(19) United States
(12) Patent Application Publication
(10) Pub. No.: US 2008/0248168 A1
(43) Pub. Date: Oct. 9, 2008

(54) FROZEN MICROWAVEABLE DOUGH PRODUCTS

(76) Inventor: John Mark Black, Eden Prairie, MN (US)

Correspondence Address: FISH & RICHARDSON P.C., PO BOX 1022, MINNEAPOLIS, MN, 55440-1022, US

(21) Appl. No.: 12/123,795

(22) Filed: May 20, 2008

Related U.S. Application Data
(63) Continuation-in-part of application No. PCT/US2007/065637, filed on Mar. 30, 2007.
(60) Provisional application No. 60/818,951, filed on Jul. 6, 2006.
(60) Provisional application No. 60/793,438, filed on Apr. 20, 2006.

(51) Int. Cl. A21D 10/00; A23P 1/08; A23L 1/31; A23L 1/025

(52) U.S. Cl. 426/92; 426/549; 426/100; 426/302; 426/275; 426/243; 426/555

(57) ABSTRACT

A frozen microwavable dough product is disclosed which can be placed from the frozen state directly into a baking oven, such as a microwave oven, without “slack time,” producing a baked bread product that is acceptable to consumers. Some embodiments can contain a partially or fully enrobed portion containing various food components, resulting in, for example, a frozen microwavable sandwich or pizza. Methods of making the frozen microwavable dough products are also disclosed, including a step of quick freezing of the products for frozen storage following proofing.

### CROSS-REFERENCE TO RELATED APPLICATIONS

This application is a continuation-in-part of PCT Application Serial No. PCT/US2007/065637, filed Mar. 30, 2007, which claims priority to U.S. Provisional Application Ser. No. 60/818,951, filed on Jul. 6, 2006 and U.S. Provisional Application Ser. No. 60/793,438, filed Apr. 20, 2006, all of which are incorporated by reference in their entirety.

### TECHNICAL FIELD

The present application relates to frozen microwavable doughs and products incorporating frozen microwavable doughs, such as bread, sandwich, and pizza products, and methods of making such products. A frozen microwavable dough product which can be cooked via microwave radiation directly from the frozen state is also provided.

### BACKGROUND

Grain-based baked products, such as breads, have been a food staple for man since biblical times. Some type of finely ground grain is combined with additional ingredients, such as sweeteners, eggs, fats, milk, etc., and the resulting dough is baked to produce a baked product with moderate storage stability. Generally, such a dough mixture is freshly prepared from the selected ingredients shortly before baking. The fresh dough has limited stability and is time consuming to prepare.

Food scientists have developed refrigerated dough products available from the refrigerated section at grocery stores in the U.S., but these products often require proofing prior to baking, and they are not generally frozen products. The frozen bread dough products that currently exist can require thawing and may also require proofing before they can be baked. These products can be specially formulated to survive freezing and thawing while still producing a baked food product acceptable to consumers. Generally, frozen bread dough is thawed to ambient temperature and then is allowed to rise (proof) at a non-baking temperature somewhat above normal ambient temperatures to provide an expanded open grain dough structure that is baked in an oven to produce a suitable finished product. The time allowed for the thawed dough to rise or proof is termed the “slack time” in the baking industry.

Variations in these procedures have been developed to shorten the overall bread-making process. The manufacturer may allow the freshly made dough to rise, then partially bake or “par bake” the item to set the dough structure. The par baked product is then frozen for distribution to consumers who finish baking, e.g., in a conventional oven, the par baked product just prior to consumption. These are the well-known “brown-and-serve” baked bread products.

Freezing breads and other dough products can be problematic because a number of physical changes occur during frozen storage of foods. Among these are changes involving growth in the average size of ice crystals mostly due to temperature fluctuations during storage. Other changes that can occur in frozen foods are precipitation of solute from the unfrozen phase due to supersaturation, protein insolubilization due to cross-linking, polymer aggregation, lipid oxidation and pigment changes caused by oxidation or hydrolysis. Dough products can also offer special problems because of accelerated staling and moisture loss. Staling rate increases as temperature decreases until the aqueous phase is frozen and starch can no longer crystallize. In order to prevent staling, it may be necessary to bring the product through the temperature zone of +10° C. (50° F.) to '5° C. as rapidly as possible during the freezing process itself.

Various enrobed or crust-containing food products have been developed which combine a bread dough and a filling or topping material. When the food product is then frozen, the product may require a “slack time” to allow the frozen dough portion to rise prior to baking in a conventional oven or microwave oven in order to produce a suitable finished bread product.

It would be useful to provide frozen dough products that can be placed in the frozen state directly into a microwave oven, without “slack time,” to produce a cooked food product that is acceptable to consumers.

### SUMMARY

Accordingly, the disclosure provided herein relates to a frozen microwavable dough product including from about 38 to about 55% by weight of flour, from about 2.0 to about 6.0% by weight of baker's yeast, from about 0.5 to about 2.0% by weight salt, from about 0.2 to about 1.0% by weight granulated sucrose, from about 1.0 to about 3.0 weight percent of an emulsifier, from about 2.0 to about 6.0% by weight of a food grade oil, from about 4.0 to about 12.0 weight percent of a sweetener, such as a liquid sweetener, from about 0.2 to about 2.0% by weight of a leavening product, from about 0.2 to about 2.0% by weight of gluten, such as a high strength gluten, and from about 20.0 to about 50.0 weight percent of water. In certain embodiments the frozen microwavable dough product will include bread flour, white, rye, hard red winter wheat, or whole wheat flours, or mixtures thereof, the emulsifier can be a mixture of from about 0.2 to about 2.0% by weight of 90 K hydrated glyceryl monostearate and from about 0.2 to about 3.9% by weight of sodium stearoyl lactylate (SSL); the sweetener can be liquid high fructose corn syrup; and the leavening agent can be a mixture of from about 0.1 to about 1.0% by weight of non-encapsulated sodium bicarbonate and from about 0.1 to about 1.0% by weight of monocalcium phosphate.

A frozen microwavable product described herein can be cooked either in a microwave oven or by other conventional cooking systems without a need for thawing or further proofing prior to being cooked. The finished frozen dough product can continue to rise during microwave cooking or other conventional cooking processes. In some embodiments, a Maillose solution may be sprayed onto the dough product in an amount of from about 1.0 to about 5.0% by weight to provide for an enhancement of natural browning reactions during cooking, e.g., in a microwave.

In an additional aspect of the present disclosure, the preparation of a frozen microwavable enrobed sandwich product is described. A dough as described herein, when unfrozen, can be wrapped around other food components such as meats, eggs, cheeses, tomato sauces, fruits, vegetables, soy products, condiments and the like, and then frozen (e.g., flash frozen) to result in a frozen microwavable enrobed sandwich product. In some embodiments, the food components may only be partially enrobed in the dough product (e.g., a hamburger), while in others the dough may fully cover the food components (e.g., sandwich, calzone). In other embodiments, the dough of the present disclosure may provide a base or crust for a frozen microwavable product, e.g., a pizza, in which other food components such as those described previously are placed on the top surface of the dough.

A further embodiment of the application is directed to a frozen microwavable bread dough that is bakeable or cookable, e.g., in a microwave, from the frozen state to a cooked product without intervening slack time. The dough includes, generally, a structure providing amount of flour and a sweetener, such as a fluid corn syrup. The dough contains an effective amount of yeast to provide a finished product of desired density, and an effective amount of an emulsifier. The dough also includes an effective amount of a leavening agent, e.g., a non-encapsulated leavening agent, to give the finished product a desired density. Once prepared and frozen, the frozen microwavable dough is stable under freezer temperature conditions and bakes from a frozen state directly to a bread consistency without slack time, using either microwave energy or convection/conventional oven heating. In some embodiments, microwave energy is preferred.

In a further embodiment of the disclosure, food components such as meat, eggs, vegetables, cheese, fruit, soy products, tomato sauces and the like can be enrobed in the above-described raw bread dough, e.g., as a filling. The food components may be pre-cooked and/or pre-cut. The food components can be fully or partially enrobed with the dough or placed on a single surface of the dough. The resulting product is frozen for distribution and storage, and can be cooked from the frozen state. Either microwave energy or convection/conventional oven heating is suitable for cooking the frozen microwavable dough product.

Typically, freezing is accomplished very quickly, e.g., in a time period from about 30 seconds to about 20 minutes, from about 30 seconds to about 10 minutes, or from about 30 seconds to about 3 minutes, although the size and weight of the frozen dough product will affect the length of the freezing operation. It will be appreciated, however, that a freezing process which is very rapid is preferred to further enhance the quality of the frozen dough product during frozen storage. In some embodiments, flash freezing is employed using methods known to those having skill in the art.

In some embodiments, a frozen microwavable dough product is provided, made by mixing dry ingredients including from about 38 to about 55% by weight of flour, from about 2.0 to about 6.0% by weight of baker's yeast, from about 0.5 to about 2.0% by weight salt, from about 0.2 to about 1.0% by weight granulated sucrose, from about 0.2 to about 2.0% by weight of a leavening agent, and from about 0.2 to about 2.0% by weight of gluten (e.g., high strength gluten); liquid ingredients including from about 1.0 to about 3.0 weight percent of an emulsifier, from about 2.0 to about 6.0% by weight of a food grade oil, from about 4.0 to about 12.0 weight percent of a sweetener (e.g., a liquid sweetener), and from about 20.0 to about 50.0 weight percent of water. Resting, proofing, forming, and filling of the dough can then be performed prior to freezing to result in the frozen microwavable dough product.

In other embodiments of the present disclosure, the frozen microwavable dough product is made by a method comprising the steps of mixing the aforementioned dry ingredients, liquid ingredients and water; wherein the step of mixing includes sequentially mixing, first the flour and the baker's yeast; then adding and mixing the other dry ingredients; then adding and mixing the liquid ingredients with the exception of water; then incrementally adding and simultaneously mixing in the water to form the dough. After the dough mixture is mixed to be extensible, the dough is rested at ambient temperature for about 30 to about 60 minutes.

In some embodiments, the rested dough is further processed by cutting and rounding the dough mixture into dough segments, proofing the dough segments, e.g., at from about 100 to about 130° F. at a relative humidity of from about 60 to about 100% relative humidity for from about 10 to about 30 minutes; and quickly freezing the dough segments, e.g., by reducing the temperature of the dough segments to at least about 0° F. or less in a period of time of from about 30 seconds to about 20 minutes, to form a frozen dough product. The frozen dough product can then be retained in frozen storage until one desires to cook it.

In yet other embodiments, such as sandwich or pizza embodiments, the previously described rested dough can be modified further by sheeting, cutting, and forming the dough into an unfrozen dough product, and optionally spraying the surface of the dough with a from about 1.0 to about 5.0% solution of Maillose. Onto the surface of the optionally sprayed dough product, food components, e.g., from about 1.0 to about 4.0 inches in diameter, are placed, which is then covered by a second sheet of unfrozen dough product, followed by optional spraying of the surface of the dough with a solution of Maillose. The unfrozen dough product is then proofed, e.g., at from about 100 to about 130° F. at a relative humidity of from about 60 to about 100% for from about 10 to about 30 minutes. In certain embodiments, an additional step may be added in order to set the bottom of the dough for storage and to increase stability in transport. The unfrozen dough product may be optionally heated from the bottom, e.g., frying, baking, searing, or grilling at a temperature from about 250 to about 280° F. for from about 2 to about 5 minutes, or until the dough product reaches a temperature from about 175 to about 200° F. The unfrozen dough product can also be optionally par-baked, e.g., in an oven at a temperature from about 260 to about 290° F. for from about 5 to about 10 minutes. Freezing the dough product can be accomplished by reducing the temperature of the unfrozen dough product, e.g., to a temperature of at least 0° F. or less in a period of time from about 30 seconds to about 20 minutes to form a frozen dough product. The frozen dough product is then retained in frozen storage until heated by cooking, e.g., in a microwave.

In further embodiments, the rested dough can be further developed by sheeting, cutting, and forming the dough into an unfrozen dough product, and optionally spraying the surface of the dough with a from about 1.0 to about 5.0% solution of Maillose. Onto the surface of the sprayed dough product, food components, such as those having from about 0.05 to about 3.0 inches in diameter, are placed. The unfrozen dough product is then proofed, e.g., at from about 100 to about 130° F. at a relative humidity of from about 60 to about 100% for from about 10 to about 30 minutes. In certain embodiments, an additional step may be added in order to set the bottom of the dough for storage and to increase stability in transport. The unfrozen dough product may be optionally heated from the bottom, e.g., frying, baking, searing, or grilling at a temperature from about 250 to about 280° F. for from about 2 to about 5 minutes, or until the dough product reaches a temperature from about 175 to about 200° F. The unfrozen dough product can also be optionally par-baked in an oven at a temperature from about 260 to about 290° F. for from about 5 to about 10 minutes. Freezing the dough product is accomplished by reducing the temperature of the unfrozen dough product, e.g., to a temperature of at least 0° F. or less, in a period of time from about 30 seconds to about 20 minutes to form a frozen dough product. The frozen dough product can then be retained in frozen storage until cooked.

The frozen dough product is stable under freezer temperature conditions and bakes directly from a frozen state, without thawing, to a bread consistency using either microwave energy or convection/conventional oven heating.

### DETAILED DESCRIPTION

In this document, the following terms will have the following general meanings:

Emulsifier: A surface active substance with affinity to both water and lipids and having the ability to form an emulsion from two immiscible liquids. Typical emulsifiers include hydrated glyceryl monostearate, monoglycerides and diglycerides, datem, sodium stearoyl-2-lactylate and the like. It will be appreciated that emulsifiers including a plurality of hydroxyl groups that can interact or bind water are also water activity reducing agents. The following emulsifiers can be used in alternate embodiments of the present disclosure: sodium stearoyl-2 lactylate (SSL); calcium stearoyl-2 lactylate (CSL), ethoxylated monoglycerides (EOM); datem; sucrose esters; polysorbate 60; mono- & diglycerides; succinylated monoglycerides; lecithin; lactylate hydrate, and the like. Datem is diacetyl tartaric esters of mono- and diglycerides.

Proofing: In bread baking, this term indicates the period of time during which leavening is initiated and a product is allowed to rise after it is shaped and placed on or in pans or the like. Products are commonly proofed until doubled in size, or when a finger, lightly placed on the side of the loaf, leaves an indentation, but a product can be proofed for only a fraction of the time necessary for this to occur. Products are generally proofed in a humid, draft-free environment at a temperature of from about 100 to about 130° F. (e.g., 100 to 120° F., 105 to 125° F., 110 to 130° F., or 115 to 125° F.), at a relative humidity of from about 60 to about 100% (e.g., 60 to 75%, 65 to 80%, 70 to 85%, 75 to 90%, 80 to 95%, or 85 to 100%) for from about 10 to about 40 minutes (e.g., 10 to 15 minutes, 10 to 25 minutes, 20 to 30 minutes, or 25 to 40 minutes).

Rounding, Shaping, Molding or Forming: Applied to the first and optionally subsequent molds. Typically a dough piece is processed into a desired shape with a smooth, dry outer surface. This helps minimize subsequent gas diffusion from the dough and also prepares the dough to make the final molding (shaping) more consistent.

Sheeting: A common practice in dough manufacture wherein mixed dough is fed into a hopper and extruded in a continuous sheet. Sheeting forms the dough into a usable form allowing easier cutting and formation into the production of sandwich bread or pizza crusts.

Sodium Stearoyl-2-Lactylate (SSL): An emulsifier used in bread dough to improve loaf volume, dough tolerance, gluten strength, machinability and crumb softness of the baked bread.

As noted above, the various frozen microwavable dough products presently available to consumers can require slack time to rise prior to baking. This disclosure provides a frozen microwavable dough which can be baked or cooked directly from the frozen state using microwave energy baking, conventional oven baking, or convection oven baking. In some embodiments, microwave baking is preferred. The dough product can be used in many settings, including: (1) using the dough as a stand-alone bread product; (2) using the dough to fully enrobe a food component, thereby producing a hot finished food product having a bread covered heated filling (e.g., an enrobed sandwich or calzone); (3) using the dough to partially enrobe a food component, thereby producing a hot finished food product having a bread-covered hot sandwich (e.g., a hamburger or a breakfast sandwich); or (4) using the dough to function as a base for additional food components (e.g., a pizza). Also disclosed are methods of preparing and freezing the dough composition and methods for cooking a frozen dough composition.

A frozen microwavable product can include a frozen microwavable dough. The frozen microwavable dough is first prepared as an unfrozen dough, which can typically include flour, water, yeast, salt, a leavening agent, a food grade oil, a sweetener, such as a liquid sweetener (e.g., corn syrup), sucrose, an emulsifier, and optionally gluten, in amounts as described below.

A flour component contributes to the structure of the bread dough, including the texture, taste and appearance of the final baked product. Useful flours include bread flour, white flour, rye flour, corn flour, corn meal, hard wheat flour, soft wheat flour, barley flour, high amylose flour and low amylose flour. In certain embodiments, the dough contains from about 35 to about 65 (e.g., 35 to 45%, 38 to 55%, 42 to 50%, 40 to 62%, 46 to 57%, 50 to 65%, or 53 to 57%) weight percent flour. The quality of the flour used in bread making may be judged by the viscoelastic properties of the dough, which is influenced by the quantity and quality of the gluten-forming storage proteins of the flour. As the strength and elasticity of the final bread product is determined by the strength of the gluten, in some embodiments of the disclosed dough product, gluten will be added from about 0.1 to about 3.0% (e.g., 0.2 to 0.6%, 0.4 to 1.0%, 0.6 to 1.5%, 0.5 to 2.5%, 1.0 to 2.2%, or 2.4 to 2.8%) by weight of the dough. The gluten can be high strength gluten.

In certain embodiments, the dough can contain a yeast component that provides the primary leavening action of the dough. The yeast component can be any commercially available baking yeast, e.g., those sold in dry powder form or solid chunks. In some embodiment, the yeast component is present at from about 2.0 to about 6.0 (e.g., 2.0 to 4.0, 2.5 to 4.5, 2.8 to 3.3, 3.0 to 6.0, 3.5 to 5.5, 3.8 to 4.2, 5.3 to 5.9, 2.1 to 4.7, or 3.6 to 5.8) weight percent in the dough.

In some embodiments, the dough includes from about 38 to about 55% (e.g., 44 to 54%) by weight of a flour, and from about 0.2 to about 2.0% (e.g., 0.4 to 0.8%) by weight of gluten, such as high-strength gluten. In certain embodiments, the dough will include from about 2.0 to about 6.0% (e.g., 2.5 to 3.5%) by weight baker's yeast to leaven the dough.

A dough can also include from about 0.5 to about 2.0% (e.g., 1.0 to 1.7%) by weight salt; from about 0.2 to about 1.0% (e.g., 0.4 to 0.8%) by weight granulated sucrose; from about 0.2 to about 2.0% (e.g., 0.3 to 0.8%) by weight of a leavening agent, which may include a mixture of non-encapsulated sodium bicarbonate and monocalcium phosphate; from about 1.0 to about 3.0 (e.g., 1.2 to 2.0) weight percent of an emulsifier, which can include a mixture of 90K hydrated glyceryl monostearate and sodium stearoyl lactylate (SSL); from about 2.0 to about 6.0% (e.g., 3.5 to 4.5%) by weight of a food grade oil, such as soybean oil, canola oil, low or zero trans fat oils, etc.; from about 4.0 to about 12.0% (e.g., 7.0 to 9.0%) of a sweetener, such as a liquid sweetener, which may include high fructose corn syrup; and about 25 to about 40% by weight of water.

In some embodiments, the formulation may be prepared without water, for example, as a dry blend formulation. In some embodiments, a dry blend formulation is prepared without yeast. In some embodiments, water can be added to the dry blend formulation at a later time by the consumer, for example, during preparation of the dough. In some embodiments, yeast can be added to the dry blend formulation at a later time by the consumer, for example, during preparation of the dough.

In some embodiments, a dough dry blend composition can include from about 86 to about 96% by weight flour; from about 0.5 to about 3.25% by weight gluten; from about 1.25 to about 3.25% by weight salt; from about 0.5 to about 1.6% by weight sucrose; from about 1.25 to about 2.5% by weight of an emulsifier; and from about 0.5 to about 3.25% by weight of a leavening agent.

In some embodiments, a dough wet blend composition can be prepared. Such a blend can be composed of the wet ingredients of a dough composition, with the exception of water. In some embodiments, the water may be added by the consumer during preparation of the dough.

In some embodiments, a dough wet blend composition can include from about 30 to about 33% by weight oil; from about 4 to about 7.5% by weight of an emulsifier; and from about 61.5 to about 65% by weight of a liquid sweetener.

A dough dry blend composition may be prepared by mixing the dry ingredients of a dough as described above. Similarly, a dough wet blend composition may be prepared by mixing the wet ingredients of a dough as described above. When preparing a dough from a dry blend composition and/or a wet blend composition, it may be necessary to add water and/or yeast to the composition prior to cooking. In some embodiments, a dry blend composition and a wet blend composition are mixed to prepare a dough. In some embodiments, water and/or yeast is added to the mixture of a dry blend composition and a wet blend composition. In some embodiments, a dry blend composition is mixed with one or more wet ingredients (e.g., water, liquid sweetener, and oils) to prepare a dough. In some embodiments, a wet blend composition is mixed with one or more dry ingredients (e.g., flour, sucrose, and salt) to prepare a dough.

Also included in the present disclosure is a process for preparing a freezable and/or frozen microwavable dough and frozen microwavable products. Typically, the raw dough is first prepared. A commercial mixing machine can be employed to mix the desired dough ingredients. The process includes the step of mixing together the flour and other various ingredients with the required amount of water at first speed for about 1 to 3 minutes and then at second speed for about 10 to 15 minutes, until the dough is homogeneous and extensible. The raw dough is then allowed to rest at ambient temperature for from about 20 to about 40 minutes and is then divided into units of the desired size, rounded and proofed, and quick frozen (or flash frozen) for storage and distribution. Where microwave heating is employed to bake the frozen dough, the raw dough can be sprayed or brushed with an aqueous caramel coloring solution prior to freezing and packaging. A coloring material denoted as Maillose is available from Red Arrow Products Company, Manitowoc, Wis. When heated, the Maillose solution provides a brown, roasted color to the exterior of the baked dough product. Maillose can be optionally applied post-proofing and/or post-freezing.

A process for preparing a frozen microwavable product which includes a portion which is at least partially surrounded (e.g., partially enrobed) by a frozen microwavable dough is also provided. The dough ingredients can be mixed and rested as described previously, and then the dough is formed into the desired shape (e.g., sheeted, cut, rolled, etc.). The dough can optionally then be sprayed with a Maillose solution from about 1.0 to about 5.0% by weight, followed by placing additional desired food components (e.g., of from about 1.0 to about 4.0 inches in diameter) onto the dough product. The additional food components can partially, substantially, or entirely cover the available surface of the dough product. The additional food components can include hot dogs, hamburgers, other meat products (e.g., pepperoni, sausage, turkey, pork, lamb, beef, ground beef, SPAM™, bacon, chicken or ham), cheese, tofu, other soy based products, eggs (including egg substitutes, liquid egg products, etc.), vegetables (e.g., peppers, olives, tomatoes, onions, garlic, broccoli, asparagus, or spinach), fruits (e.g., apples, bananas, cherries, strawberries, blueberries, raspberries, or pears), nuts (e.g., walnuts, almonds, pecans, or peanuts), tomato sauce, chocolate, frostings or fillings, or condiments (e.g., catsup, mayonnaise, salsa, mustard, or relish). The food components are then covered, either partially or fully, by a second portion of dough, which is optionally sprayed with a Maillose solution, and the resulting product is proofed.

In some embodiments, heat may be introduced to the bottom of the proofed product to further enhance the shelf stability of the resulting product, e.g., frying, baking, searing, or grilling the bottom of the product may be heated to a temperature from about 250 to about 280° F. for from about 2 to about 5 minutes, or until the dough product reaches a temperature from about 175 to about 200° F. The unfrozen dough product can also be optionally par-baked in an oven, e.g., at a temperature from about 260 to about 290° F. for from about 5 to about 10 minutes, and then quickly frozen.

In another embodiment of the present application, a frozen microwavable pizza product is made using the frozen microwavable dough described herein. The process described above to produce the partially or fully enrobed sandwich product can be used to prepare such a product, with the exception that the dough is used as a base or crust for the additional food components and no additional portion of dough is necessary. The food components can be placed on the surface of the dough in sizes typical for a pizza product, e.g., from about 0.05 to about 3.0 inches in diameter, and may include any of the above described food components. After the food components have been placed, the pizza can be proofed, optionally heated (e.g., grilling) on the bottom portion, optionally par-baked in the oven, and then quickly frozen.

Freezing food has many advantages over other means of preservation, such as thermal processing, because it can provide better organoleptic quality and somewhat better retention of nutrients in the finished product. In addition, most food spoilage organisms cannot grow at frozen food storage temperatures and a reduction in their numbers may actually occur. During freezing, however, moisture in the matrix of frozen dough products will sublimate while in frozen storage unless efforts are made to bind free moisture to minimize sublimation and loss of such moisture which renders frozen dough product less and less desirable as moisture loss increases. For this reason, moisture often will accumulate on the product surface. If, and when the temperature gradient reverses, the moisture will not migrate back to its original location. Lower frozen storage temperatures are also encouraged, but the commercial provider has limited control of storage temperatures. Dough products offer special problems because of accelerated staling and moisture loss. Staling rate increases as temperature decreases until the aqueous phase is frozen and starch can no longer crystallize. In order to prevent staling it is necessary to bring the product through the temperature zone of +10° C. (50° F.) to −5° C. as rapidly as possible during the freezing process itself.

One way of reducing moisture migration and loss and staling is to freeze the dough products as quickly as possible by one of several “flash” freezing methods known to those having skill in the art. Broadly speaking, methods of “flash” freezing may be defined as either mechanical or cryogenic. Closed mechanical systems require a compressor, a condenser, an expansion valve and an evaporator. Cryogenic systems are open and use either liquid nitrogen, carbon dioxide or ambient air.

Also included in the present application is a method by which to cook any of the frozen microwavable dough products described herein. The frozen microwavable dough products may be baked directly from a frozen state, without thawing, to a desirable bread consistency using either microwave energy or convection/conventional oven heating. If using a microwave, the frozen microwavable dough product may be cooked on a plate, napkin, paper towel, plastic container, glass cooking dish, metallized microwave susceptor film, paper container, or other specialized or accepted microwave-safe cooking receptacle.

In one embodiment, one might use a tray composed of a fibrous (e.g., paper) material which has vertically extended walls on all sides that are spaced apart a specified distance to abut the frozen microwavable dough product during cooking, thereby at least partially restraining the dough from expanding in a horizontal direction. This type of cooking receptacle may increase the height of the final cooked dough product, increasing the appeal of the cooked dough product to the consumer. In another embodiment, the frozen microwavable dough product may be confined in a specialized tray composed of a fibrous material (e.g., paper) containing perforations spaced appropriately to provide a location for the release of condensation which may form during cooking. The tray may have walls sized to encourage (e.g., constrain) the dough to expand in a vertical rather than a horizontal direction upon heating. In further embodiments, the tray may be situated from a distance of about 0.25 to about 3 inches (e.g., 0.25, 0.5, 0.75, 1.0, 1.25, 1.5, 1.75, 2.0, 2.25, 2.5, 2.75, or 3 inches) above the floor of the microwave to allow for even cooking on all sides. The frozen microwavable dough product can be heated until the dough has been completely cooked and the additional ingredients, if present, are sufficiently hot. For example, if a 135 g (4 oz.) sandwich product composed of the frozen microwavable dough product were to be cooked in a microwave, it could be cooked on high for 1-2 minutes, and allowed to set for an additional 1-2 minutes prior to consumption.

A further object of the present disclosure is to provide a frozen microwavable dough product in which the step of proofing the dough prior to freezing utilizes only a portion, preferably only about 20 to about 60, more preferably only about from about 30 to about 40% of the leavening capacity of the dough and/or allows a rise of from about 20 to about 60, preferably from about 30 to about 40% of the projected rise resulting from the leavening process as compared to a comparable dough product that has not been frozen, prior to freezing such that upon heating the bread dough matrix after frozen storage, whether by microwave cooking or other cooking processes, causes a further rise of from about 80 to about 40, preferably from about 70 to about 60% of the projected rise of the dough caused by the leavening capacity of the dough (e.g., as compared to a comparable dough product that has not been frozen).

A preferred bread dough composition disclosed in the following example was formulated to better illustrate the scope of the present disclosure.

### EXAMPLE 1

A bread dough composition having the ingredients as detailed in Table 1, all measured by weight, are combined according to the method outlined above.

TABLE 1
Ingredients in a frozen microwavable dough product.

| Ingredient | Quantity (g) | Total % |
|---|---|---|
| Flour - Bread Flour | 718.5 | 39.92% |
| Ultragrain Hard Red Winter Flour | 239.5 | 12.32% |
| Gluten- High Strength | 9.6 | 0.53% |
| Yeast | 57.5 | 3.19% |
| Salt | 21.6 | 1.20% |
| Sucrose | 10.8 | 0.60% |
| Oil | 71.9 | 3.99% |
| GMS 90K (Hydrated Glyceryl | 9.6 | 0.53% |
| Monostearate) | | |
| SSL | 19.2 | 1.06% |
| High Fructose Corn Syrup - 42% | 143.7 | 7.98% |
| Monocalcium phosphate | 4.8 | 0.27% |
| Non-encapsulated sodium bicarbonate | 4.8 | 0.27% |
| Water | 488.6 | 27.14% |
| Total | 1800.0 | 100.00% |

After mixing and incorporation of the ingredients, the dough is mixed on first speed for one minute and then second speed for 13 minutes. The dough is allowed to rest at ambient temperature for 30 minutes. After the resting period, the dough is cut, rounded and formed. The dough is proofed at 110° F. at 90% relative humidity for 30 minutes followed by an application of a 3.0% Maillose solution. Once proofed, the dough is placed immediately into the freezer at 0° F. until completely frozen (about 4 hours), and then packaged into poly bags and held frozen until use.

### EXAMPLE 2

Using the frozen microwavable dough product composition as detailed in Example 1, a frozen microwavable fully-enrobed sandwich product is assembled. After mixing and resting as described above, the dough is sheeted on a sheeter, and a sheet of dough is placed loosely over a hamburger pan (3.5 inch diameter depressions). The dough surface is optionally sprayed with a 3% Maillose solution. Refrigerated, previously-cut sandwich components (2.5 inches in diameter) are placed in the center of the dough depressions. A second dough is sheeted as the first, optionally sprayed with Maillose solution and placed Maillose side-down over the first sheet. The sandwiches are cut with a 4 inch diameter cookie cutter and the excess dough is removed. The assembled sandwiches are proofed at 110° F. at 90% relative humidity for 30 minutes. The bottom of the proofed sandwiches can optionally be heated to 270° F. for 3-3.5 minutes or until the dough reaches a temperature of 190° F., by grilling on the surface of a grill. The sandwiches can also then be par-baked in an oven set to 280° F. for 7 minutes. Either or both of these final two steps can be omitted, but may be used to enhance shelf stability and/or to set the dough for commercialization. The un-baked or par-baked sandwiches are placed immediately in the freezer at 0° F. until cool to the touch (about 1 hour). The sandwiches are then removed from the freezer and sprayed with a 3% Maillose solution and returned to the freezer until completely frozen (about 3 hours). The frozen sandwiches are packed into poly bags and held frozen until use. To cook and heat the sandwiches, the product is removed from the freezer and placed in the microwave for cooking, e.g., on a glass or paper plate, a napkin, or any suitable microwave packaging, including microwave susceptor packaging, and heated in a microwave oven for 1.5 to 2 minutes. The sandwich is then allowed to sit for 1-2 minutes to equilibrate. Alternatively, the sandwich may be heated in a conventional oven for approximately 20 minutes at 325° F.

### EXAMPLE 3

Using the frozen microwavable dough product composition as detailed in Example 1, a frozen microwavable pizza product is made. After mixing and resting as described above, the dough is cut, formed and optionally sprayed with a 3% Maillose solution. Refrigerated, previously-cut pizza components (1.5 inches in diameter) are placed on the surface of the dough. The assembled pizza is proofed at 110° F. at 90% relative humidity for 30 minutes and further optionally sprayed with a 3% Maillose solution. The bottom of the proofed pizza may be optionally heated to 270° F. for 3-3.5 minutes or until the dough reaches a temperature of 190° F., by grilling on the surface of a grill. The pizza may then be par-baked in an oven set to 280° F. for 7 minutes. These final two steps can be used to enhance shelf stability and to set the dough for commercialization. The unbaked or par-baked pizza is placed immediately in the freezer at 0° F. until frozen (about 4 hours). The frozen pizza is packed into poly bags and held frozen until use.

### EXAMPLE 4

A bread dough dry blend and wet blend composition having the ingredients as detailed in Tables 2 and 3, respectively, all measured by weight, are combined according to the method outlined above.

TABLE 2
Ingredients in a frozen microwavable dough dry blend
composition.

| Ingredient | Weight % |
|---|---|
| Flour - Bread Flour | 71.07 |
| Ultragrain Hard Red Winter Flour | 21.93 |
| Gluten- High Strength | 0.94 |
| Salt | 2.14 |
| Sucrose | 1.07 |
| SSL | 1.89 |
| Monocalcium phosphate | 0.48 |
| Non-encapsulated sodium bicarbonate | 0.48 |
| Total | 100.00 |

TABLE 3
Ingredients in a frozen microwavable dough wet blend
composition.

| Ingredient | Weight % |
|---|---|
| Oil | 31.92 |
| GMS 90K (Hydrated Glyceryl | 4.24 |
| Monostearate) | |
| High Fructose Corn Syrup - 42% | 63.84 |
| Total | 100.00 |

While the objects of this disclosure has been particularly shown and described with reference to preferred embodiments thereof, it will be understood by those skilled in the art that various changes in form and details may be made therein without departing from the spirit and scope of the application.

What is claimed is:

1. A frozen microwavable dough product, wherein the dough of said frozen microwavable dough product comprises:
a. from about 38 to about 55% by weight of flour;
b. from about 2.0 to about 6.0% by weight of baker's yeast;
c. from about 0.5 to about 2.0% by weight salt;
d. from about 0.2 to about 1.0% by weight granulated sucrose;
e. from about 1.0 to about 3.0 weight percent of an emulsifier;
f. from about 2.0 to about 6.0% by weight of a food grade oil;
g. from about 4.0 to about 12.0% weight percent of a liquid sweetener;
h. from about 0.2 to about 2.0% by weight of a leavening agent;
i. from about 0.2 to about 2.0% by weight of gluten; and
j. from about 20.0 to about 50.0 weight percent of water.

2. The frozen microwavable dough product of claim 1, wherein the flour is selected from bread flour, white flour, rye flour, corn flour, corn meal, hard red winter wheat flour, whole wheat flour, and mixtures thereof.

3. The frozen microwavable dough product of claim 1, wherein the emulsifier comprises a mixture of 90K hydrated glyceryl monostearate and SSL.

4. The frozen microwavable dough product of claim 3, wherein the 90K hydrated glyceryl monostearate is present from about 0.2 to about 2.0% by weight.

5. The frozen microwavable dough product of claim 3, wherein the SSL is present from about 0.2 to about 3.0% by weight.

6. The frozen microwavable dough product of claim 1, wherein the sweetener is high fructose corn syrup.

7. The frozen microwavable dough product of claim 1, wherein the leavening agent comprises a mixture of non-encapsulated sodium bicarbonate and monocalcium phosphate.

8. The frozen microwavable dough product of claim 7, wherein the non-encapsulated sodium bicarbonate is present from about 0.1 to about 1.0% by weight.

9. The frozen microwavable dough product of claim 7, wherein the monocalcium phosphate is present from about 0.1 to about 1.0% by weight.

10. A frozen microwavable product including a portion comprising food components at least partially enrobed by a frozen microwavable dough, the frozen microwavable dough comprising:
a. from about 38 to about 55% by weight of flour;
b. from about 2.0 to about 6.0% by weight of baker's yeast;
c. from about 0.5 to about 2.0% by weight salt;
d. from about 0.2 to about 1.0% by weight granulated sucrose;
e. from about 1.0 to about 3.0 weight percent of an emulsifier;
f. from about 2.0 to about 6.0% by weight of a food grade oil;
g. from about 4.0 to about 12.0% weight percent of a liquid sweetener;
h. from about 0.2 to about 2.0% by weight of a leavening agent;
i. from about 0.2 to about 2.0% by weight of high strength gluten; and
j. from about 20.0 to about 50.0 weight percent of water.

11. The frozen microwavable product of claim 10, wherein the flour is selected from bread flour, white flour, rye flour, corn flour, corn meal, hard red winter wheat flour, whole wheat flour, and mixtures thereof.

12. The frozen microwavable product of claim 10, wherein the emulsifier comprises a mixture of 90K hydrated glyceryl monostearate and SSL.

13. The frozen microwavable product of claim 12, wherein the 90K hydrated glyceryl monostearate is present from about 0.2 to about 2.0% by weight.

14. The frozen microwavable product of claim 12, wherein the SSL is present from about 0.2 to about 3.0% by weight.

15. The frozen microwavable product of claim 10, wherein the sweetener is high fructose corn syrup.

16. The frozen microwavable product of claim 10, wherein the leavening agent comprises a mixture of non-encapsulated sodium bicarbonate and monocalcium phosphate.

17. The frozen microwavable product of claim 16, wherein the non-encapsulated sodium bicarbonate is present from about 0.1 to about 1.0% by weight.

18. The frozen microwavable product of claim 16, wherein the monocalcium phosphate is present from about 0. 1 to about 1.0% by weight.

19. The frozen microwavable product of claim 10, wherein the food components are selected from the group consisting of meats, eggs, cheeses, tomato sauces, condiments, soy products, fruits, and vegetables.

20. The frozen microwavable product of claim 19, wherein the food components of the frozen microwavable dough product are fully enrobed.

21. The frozen microwavable product of claim 20, wherein the frozen microwavable dough product is a sandwich.

22. A frozen microwavable product comprising food components on a surface of a frozen microwavable dough, the frozen microwavable dough comprising:
a. from about 38 to about 55% by weight of flour;
b. from about 2.0 to about 6.0% by weight of baker's yeast;
c. from about 0.5 to about 2.0% by weight salt;
d. from about 0.2 to about 1.0% by weight granulated sucrose;
e. from about 1.0 to about 3.0 weight percent of an emulsifier;
f. from about 2.0 to about 6.0% by weight of a food grade oil;
g. from about 4.0 to about 12.0% weight percent of a sweetener;
h. from about 0.2 to about 2.0% by weight of a leavening agent;
i. from about 0.2 to about 2.0% by weight of high strength gluten; and
j. from about 20.0 to about 50.0 weight percent of water.

23. The frozen microwavable product of claim 22, wherein the flour is selected from bread flour, white flour, rye flour, corn flour, corn meal, hard red winter wheat flour, whole wheat flour, and mixtures thereof.

24. The frozen microwavable product of claim 22, wherein the emulsifier comprises a mixture of 90K hydrated glyceryl monostearate and SSL.

25. The frozen microwavable product of claim 22, wherein the 90K hydrated glyceryl monostearate is present from about 0.2 to about 2.0% by weight.

26. The frozen microwavable product of claim 22, wherein the SSL is present from about 0.2 to about 3.0% by weight.

27. The frozen microwavable product of claim 22, wherein the sweetener is high fructose corn syrup.

28. The frozen microwavable product of claim 22, wherein the leavening agent comprises a mixture of non-encapsulated sodium bicarbonate and monocalcium phosphate.

29. The frozen microwavable product of claim 28, wherein the non encapsulated sodium bicarbonate is present from about 0.1 to about 1.0% by weight.

30. The frozen microwavable product of claim 28, wherein the monocalcium phosphate is present from about 0.1 to about 1.0% by weight.

31. The frozen microwavable product of claim 22, wherein the food components are selected from the group consisting of meats, eggs, cheeses, tomato sauces, condiments, soy products, fruits, and vegetables.

32. The frozen microwavable product of claim 22, wherein the frozen microwavable dough product is a pizza.

33. The frozen microwavable product of claims 1, 10 or 22, wherein the frozen microwavable dough comprises: 39.93% by weight bread flour; 13.31% by weight ultragrain hard red winter wheat flour; 0.53% by weight high strength gluten; 3.19% by weight yeast; 1.20% by weight salt; 0.60% by weight sucrose; 3.99% by weight food grade oil; 0.53% by weight 90K hydrated glyceryl monostearate; 1.06% by weight SSL; 7.98% by weight high fructose corn syrup; 0.27% by weight monocalcium phosphate; 0.27% by weight non-encapsulated sodium bicarbonate; and 27.14% by weight water.

34. A method for preparing a dough product, the method comprising the steps of:
a. providing the following ingredients: 1) from about 38 to about 55% by weight of flour; 2) from about 2.0 to about 6.0% by weight of baker's yeast; 3) from about 0.5 to about 2.0% by weight salt; 4) from about 0.2 to about 1.0% by weight granulated sucrose; 5) from about 1.0 to about 3.0 weight percent of an emulsifier; 6) from about 2.0 to about 6.0% by weight of a food grade oil; 7) from about 4.0 to about 12.0% weight percent of a liquid sweetener; 8) from about 0.2 to about 2.0% by weight of a leavening product; 9) from about 0.2 to about 2.0% by weight of high strength gluten; 10) from about 20.0 to about 50.0 weight percent of water;
b. adding the flour and the yeast to a mixing container and mixing them together to form a dry flour and yeast mixture;
c. adding the salt and the granulated sucrose to the dry flour and yeast mixture and mixing same to form a dry ingredients mixture;
d. adding the remaining ingredients, with the exception of the water, to the mixed dry ingredients mixture and mixing to form a pre-dough mixture;
e. adding the water to the pre-dough mixture and mixing until the resulting dough is extensible; and
f. allowing the dough to rest.

35. The method of claim 34, further comprising:
a. forming the dough into an unfrozen dough product;
b. proofing the unfrozen dough product; and
c. optionally spraying the dough surface with a from about 1.0 to about 5.0% by weight solution of Maillose.

36. The method of claim 34, further comprising:
a. forming the dough into an unfrozen dough product;
b. optionally spraying the dough surface with a from about 1.0 to about 5.0% by weight solution of Maillose;
c. placing food components onto the surface of the unfrozen dough product;
d. covering the unfrozen dough product and its food components with a second unfrozen dough product and optionally sealing the edges of the two unfrozen dough products together;
e. proofing the unfrozen dough product; and
f. optionally spraying the second dough surface with a from about 1.0 to about 5.0% by weight solution of Maillose.

37. The method of claim 34, further comprising a. forming the dough into an unfrozen dough product;
b. placing food components on the surface of the unfrozen dough product;
c. proofing the unfrozen dough product; and
d. optionally spraying the dough surface with a from about 1.0 to about 5.0% by weight solution of Maillose.

38. The method of claim 35, further comprising freezing the dough product.

39. The method of claim 36 or 37, further comprising steps a) and/or b) below, followed by step c):
a. heating the bottom of the unfrozen dough product;
b. par-baking the unfrozen dough product; and
c. freezing the dough product.

40. The method of claim 36 or 37, wherein the food components are selected from the group consisting of meat, eggs, cheese, tomato sauce, condiments, soy products, fruits and vegetables.

41. A method of preparing a cooked bread product from a frozen microwavable dough product comprising:
a. removing the frozen microwavable dough product from frozen storage; and
b. without prior thawing of the frozen microwavable dough product, heating the frozen microwavable dough product in a microwave for a sufficient time to cook the frozen microwavable dough product, thereby preparing the cooked bread product.

42. A method of preparing a cooked bread product from a frozen microwavable dough product comprising:
a. removing the frozen microwavable dough product from frozen storage; and
b. without prior thawing of the frozen microwavable dough product, heating the frozen microwavable dough product in a microwave, using a provided specialized microwave tray, for a sufficient time to cook the frozen microwavable dough product, thereby preparing the cooked bread product.

43. The method of claim 42, wherein the specialized microwavable tray confines the frozen microwavable dough product to encourage expanding of the frozen microwavable dough product in a vertical direction upon cooking, increasing the height of the final cooked bread product when compared to that prepared without the specialized microwavable tray.

44. The method of claim 42, wherein the specialized microwavable tray confines the frozen microwavable dough product to restrain the frozen microwavable dough from expanding in a horizontal direction upon cooking.

45. A frozen microwavable dough dry blend composition, comprising:
a. from about 86 to about 96% by weight of flour;
b. from about 1.25 to about 3.25% by weight salt;
c. from about 0.5 to about 1.6% by weight granulated sucrose;
d. from about 1.25 to about 2.5 weight percent of an emulsifier;
e. from about 0.5 to about 3.25% by weight of a leavening agent; and
f. from about 0.5 to about 3.25% by weight of gluten;
wherein all of said percentages are weights based on the total weight of the dry blend composition.

46. The frozen microwavable dough dry blend composition of claim 45, the dry blend comprising:
a. about 93% by weight of flour;
b. about 2.14% by weight salt;
c. about 1.07% by weight granulated sucrose;
d. about 1.89 weight percent of an emulsifier;
e. about 0.48% by weight of a leavening agent; and
f. about 0.94% by weight of gluten.

47. A frozen microwavable dough wet blend composition, comprising:
a. from about 4 to about 7.5 weight percent of an emulsifier;
b. from about 30 to about 33% by weight of a food grade oil; and
c. from about 61.5 to about 65 weight percent of a liquid sweetener;
wherein all of said percentages are weights based on the total weight of the wet blend composition.

48. The frozen microwavable dough wet blend composition of claim 47, the wet blend comprising:
a. about 4.24 weight percent of an emulsifier;
b. about 31.92% by weight of a food grade oil; and
c. about 63.84 weight percent of a liquid sweetener.
